(19) United States
(12) Patent Application Publication
(10) Pub. No.: US 2026/0052468 A1
(43) Pub. Date: Feb. 19, 2026

(54) METHODS AND SYSTEMS FOR SAVING NETWORK ENERGY IN SPATIAL DOMAIN USING ADAPTATION INFORMATION

(71) Applicant: Samsung Electronics Co., Ltd., Suwon-si, Gyeonggi-do (KR)

(72) Inventors: Santanu MONDAL, Bangalore (IN); Diwakar SHARMA, Bangalore (IN); Dattaraj Dileep Raut MULGAONKAR, Bangalore (IN); Junyung YI, Suwon-si (KR); Youngbum KIM, Suwon-si (KR); Karthik MURALIDHAR, Bangalore (IN)

(21) Appl. No.: 19/103,389

(22) PCT Filed: Aug. 11, 2023
(86) PCT No.: PCT/KR2023/011941

§ 371 Date: Feb. 12, 2025

(30) Foreign Application Priority Data
Aug. 12, 2022 (IN) 202241046216
Aug. 12, 2022 (IN) 202241046217
Jun. 13, 2023 (IN) 202241046216
Jul. 14, 2023 (IN) 202241046217

(51) Int. Cl. H04W 52/02; H04B 7/06; H04L 5/00; H04W 24/10; H04W 72/23

(52) U.S. Cl. CPC H04W 52/0206; H04B 7/0626; H04L 5/0048; H04W 24/10; H04W 72/23

(57) ABSTRACT

The disclosure relates to a 5G or 6G communication system for supporting a higher data transmission rate. Embodiments herein provide a method for network energy saving (NES) performed by abase station in a wireless communication system. The method includes transmitting, to a terminal, an indication of channel state information (CSI) reference signal (CSI RS) ports, and receiving, from a terminal, a measurement report message comprising information on CSI report based on the indication, wherein the indication comprises at least one subset of CSI RS ports for energy saving.

### TECHNICAL FIELD

Embodiments disclosed herein relate to wireless communication networks, and more particularly methods and a network apparatus to saving energy in the wireless communication networks using power adaptation information (e.g., port power adaptation information).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and apolar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as abasis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### DISCLOSURE OF INVENTION

### Technical Problem

The principal object of the embodiments herein is to disclose methods and systems for saving energy in a wireless communication networks (in a spatial-domain) using port power adaptation.

The principal object of the embodiments herein is to disclose methods and systems for saving energy in a wireless communication networks (in a spatial-domain) using port beam adaptation.

Another object of the embodiments herein is to send a configuration message comprising power adaptation information to a UE in the wireless network to trigger abeam measurement received from the UE.

Another object of the embodiments herein is to control the energy usage in the wireless network based on the configuration message comprising the power adaptation information and a subsequent UE measurement report.

The principal object of the embodiments herein is to disclose methods and systems for saving energy in wireless communication networks (in a spatial-domain) using beam adaptation information (e.g., port beam-width adaptation or the like).

Another object of the embodiments herein is to send a configuration message including beam adaptation information to at a UE in the wireless network based abeam measurement.

Another object of the embodiments herein is to control the energy usage in the wireless network based on the configuration message including the beam adaptation information.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

Accordingly, the embodiments herein provide methods for managing energy usage in a wireless network. The method includes sending, by a network apparatus, a configuration message comprising at least one power adaptation information to at least one UE in the wireless network to trigger at least one beam measurement report from the at least one UE. Further, the method includes controlling, by the network apparatus, the energy usage in the wireless network based on the configuration message comprising the at least one power adaptation information and a subsequent beam measurement report.

In an embodiment, sending, by the network apparatus, the configuration message comprising the at least one power adaptation information to the at least one UE in the wireless network includes indicating, by the network apparatus, the at least one power adaptation information along with one of: at least one CSI-RS port, a single group of CSI-RS ports, a multiple groups of CSI-RS ports for the power adaptation information to the at least one UE, receiving, by the network apparatus, a measurement report from the at least one UE based on the indication, and sending, by the network apparatus, the configuration message comprising the at least one power adaptation information to the at least one UE in the wireless network based on the measurement report. The measurement report comprises a preference and measurement information about the at least one power adaptation information for the one of: the at least one CSI-RS port, the single group of CSI-RS ports, and the multiple groups of CSI-RS ports. Contents of the measurement report includes a CRI, RI, PMI, CQI, etc.,

In an embodiment, the power adaptation information is provided by using at least one of de-boosting all CSI-RS ports with an identical power scaling factor on a per bandwidth (BWP) or a per component carrier (CC) basis, boosting all CSI-RS ports with an identical power scaling factor on a per BWP or a per CC basis, de-boosting the power on each of a CSI-RS port with different scaling factors on a per BWP or a per CC basis, boosting the power on each of a CSI-RS port with different scaling factors on a per BWP or a per CC basis, boosting the power on a subset of the CSI-RS port and de-boosting the power on a rest of the CSI-RS port with different scaling factors on a per BWP or a per CC basis, and setting all CSI-RS ports to a same reference power on a per BWP or a per CC basis. In an example, the identical power scaling factor means that the CSI for all CSI-RS ports in a CSI resource can be measured for base power as well as 3 dB lower power. The measured channels may potentially have different RI values.

In an embodiment, the at least one beam measurement includes at least one of a Reference Signal Received Power (RSRP) measurement, a Signal to Interference Noise Ratio (SINR) measurement, a Reference Signal Received Quality. (RSRQ) measurement, a CSI-RS Resource Indicator (CRI), a Ranking Indicator (RI), a Layer Indicator (LI), a Pre-coding Matrix Indicator (PMI), and a Channel Quality Indicator (CQI).

In an embodiment, the at least one power adaptation information indicates at least one of: at least one power offset value for at least one of a configured CSI-RS resource set and at least one configured CSI-RS resource in the configured CSI-RS resource set.

In an embodiment, the power adaptation information is indicated to the at least one UE by one of: adapting a transmit power of the CSI-RS ports themselves using at least one powerControlOffsetSS value or a value update associated with the at least one powerControlOffsetSS value, and adapting the transmit power of a PDSCH that is quasi-colocated with the CSI-RS ports using at least one powerControlOffset value or a value update associated with the at least one powerControlOffset value.

Accordingly, the embodiments herein provide a network apparatus including a power adaptation controller coupled with a processor and a memory. The power adaptation controller is configured to send a configuration message comprising at least one power adaptation information to at least one UE in the wireless network to trigger at least one beam measurement report from the at least one UE. Further, the power adaptation controller is configured to control the energy usage in the wireless network based on the configuration message comprising the at least one power adaptation information and a subsequent beam measurement report.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

Accordingly, the embodiments herein provide methods for managing energy usage in a wireless network. The method includes sending, by a network apparatus, a configuration message comprising at least one beam adaptation information to at least one UE in the wireless network to trigger at least one beam measurement report from the at least one UE. Further, the method includes controlling, by the network apparatus, the energy usage in the wireless network based on the configuration message comprising the at least one beam adaptation information and a subsequent beam measurement report.

Accordingly, the embodiments herein provide a network apparatus including a beam adaptation controller coupled with a processor and a memory. The beam adaptation controller is configured to send a configuration message comprising at least one beam adaptation information to at least one UE in the wireless network to trigger at least one beam measurement report from the at least one UE. Further, the beam adaptation controller is configured to control the energy usage in the wireless network based on the configuration message comprising the at least one beam adaptation information and a subsequent beam measurement report.

In an embodiment, sending, by the network apparatus, the configuration message comprising the at least one beam adaptation information to the at least one UE in the wireless network includes indicating, by the network apparatus, one of: at least one CSI-RS port, a single group of CSI-RS ports, a multiple groups of CSI-RS ports for the beam adaptation information to the at least one UE, receiving, by the network apparatus, a measurement report from the at least one UE based on the indication, wherein the measurement report comprises a preference and measurement information for each of the beam adaptation in one of: at least one of the CSI-RS port, the single group of CSI-RS ports, and the multiple groups of CSI-RS ports, and sending, by the network apparatus, the configuration message comprising the at least one beam adaptation information to the at least one UE in the wireless network based on the measurement report.

In an embodiment, the beam adaptation information is provided by widening a beam parameter for a selected set of CSI-RS ports from a candidate list of CSI-RS port subsets with a same scaling factor on a per BWP or a per Component carrier (CC) basis. In another embodiment, the beam adaptation information is provided by narrowing a beam parameter for a selected set of CSI-RS ports from a candidate list of CSI-RS port subsets with a same scaling factor on a per BWP or a per CC basis. In another embodiment, the beam adaptation information is provided by widening a beam parameter for a selected set of CSI-RS ports from the candidate list of CSI-RS port subsets with a different scaling factor on a per BWP or a per CC basis. In another embodiment, the beam adaptation information is provided by narrowing a beam parameter for a selected set of CSI-RS ports from the candidate list of CSI-RS port subsets with a different scaling factor on a per BWP or a per CC basis. In another embodiment, the beam adaptation information is provided by widening a beam parameter for a selected subset of CSI-RS ports from the a candidate list of CSI-RS port subsets and narrowing the beam parameter for a non-overlapping subset of CSI-RS ports from the candidate list of CSI-RS port subsets on a per BWP or a per CC basis. In another embodiment, the beam adaptation information is provided by widening a beam parameter, along with power boosting or de-boosting, for a selected subset of CSI-RS ports from the candidate list of CSI-RS port subsets with a corresponding same scaling factor or a different scaling factor on a per BWP or a per CC basis. In another embodiment, the beam adaptation information is provided by narrowing a beam parameter, along with the power boosting or de-boosting, for a selected subset of CSI-RS ports from the candidate list of CSI-RS port subsets with a corresponding same scaling factor or a different scaling factor on a per BWP or a per CC basis. In another embodiment, the beam adaptation information is provided by widening a beam parameter, along with power de-boosting, for the selected subset of CSI-RS ports from the candidate list of CSI-RS port subsets and narrowing the beam parameter, along with power boosting, for a non-overlapping subset of CSI-RS ports from the candidate list of CSI-RS port subsets on a per BWP or a per CC basis. In another embodiment, the beam adaptation information is provided by widening and/or narrowing beam-width of two non-overlapping subsets of CSI-RS ports, along with power boosting and/or de-boosting for them, respectively. In another embodiment, the beam adaptation information is provided by setting all CSI-RS ports to a default beam adaptation information on a per BWP or a per CC basis.

In an embodiment, at least one CSI-RS port associated with the beam adaptation information comprises at least one of a beam width, a beam angle, a beam tilt, a beam radiation pattern, and CSI-RS port power.

In an embodiment, at least one single group of CSI-RS ports associated with the beam adaptation information comprises at least one of a beam width, a beam angle, abeam tilt, a beam radiation pattern, and CSI-RS port power.

In an embodiment, at least one multiple groups of CSI-RS ports associated with the beam adaptation information comprises at least one of a beam width, a beam angle, abeam tilt, a beam radiation pattern, and CSI-RS port power.

In an embodiment, the at least one beam measurement includes at least one of a Reference Signal Received Power (RSRP) measurement, a Signal to Interference Noise Ratio (SINR) measurement, a Reference Signal Received Quality. (RSRQ) measurement, a CSI-RS Resource Indicator (CRI), a Ranking Indicator (RI), a Layer Indicator (LI), a Pre-coding Matrix Indicator (PMI), and a Channel Quality Indicator (CQI).

In an embodiment, at least one beam adaptation information involves at least one of: enabling at least one antenna element and at least one antenna sub-array associated to a logical antenna port and disabling at least one antenna element and at least one antenna sub-array associated to a logical antenna port.

In an embodiment, the beam adaptation information is indicated to the at least one UE by one of: adapting a transmit power of the CSI-RS ports themselves using at least one of a powerControlOffsetSS value and update value of the powerControlOffsetSS value, and adapting the transmit power of a PDSCH that is quasi-colocated with the CSI-RS ports using at least one of a powerControlOffset value and update value of the powerControlOffset value.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

The present disclosure provides a method and an apparatus for saving energy in a wireless communication networks (in a spatial-domain) using port power adaptation.

The present disclosure provides a method and an apparatus for saving energy in a wireless communication networks (in a spatial-domain) using port beam adaptation.

Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates an overview of a wireless network for managing energy usage, according to embodiments as disclosed herein;

FIG. 2 shows various hardware components of a network apparatus, according to the embodiments as disclosed herein;

FIG. 3 is a flow chart illustrating a method for managing energy usage in the wireless network, according to embodiments as disclosed herein;

FIG. 4 illustrates an overview of a wireless network for managing energy usage, according to embodiments as disclosed herein;

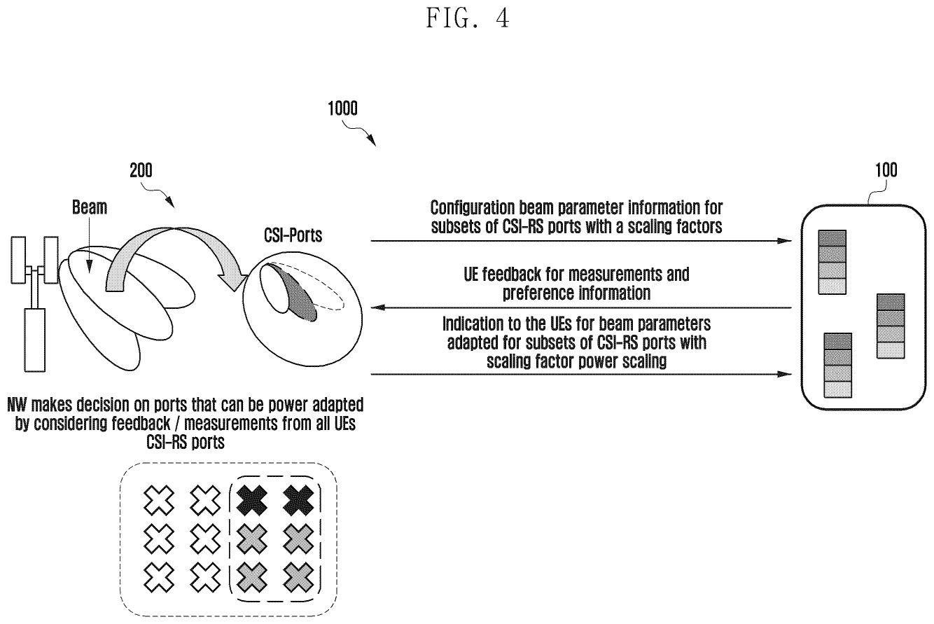

FIG. 5 shows various hardware components of a network apparatus, according to the embodiments as disclosed herein; and

FIG. 6 is a flow chart illustrating a method for managing energy usage in the wireless network, according to embodiments as disclosed herein.

### MODE FOR THE INVENTION

As per study item (SI) objectives agreed in RP-220297 for network-energy savings (NES), the following gaps have been identified.

Definition of a base station energy consumption model [RAN1]: The base station energy consumption model adapts a framework of a power consumption modelling and evaluation methodology of TR38.840 to a base station side which includes relative energy consumption for downlink (DL) and uplink (UL) (considering factors like power amplifier (PA) efficiency, number of TxRU, base station load, etc.), sleep states and the associated transition times, and one or more reference parameters/configurations.

Definition of an evaluation methodology and KPIs [RAN1]: An evaluation methodology should target for evaluating system-level network energy consumption and energy savings gains, as well as assessing/balancing impact to a network and user performance (e.g., spectral efficiency, capacity, UE packet throughputs (UPT), latency, handover performance, call drop rate, initial access performance, service level agreement (SLA) assurance related Key Performance Indicators (KPIs)), energy efficiency, and UE power consumption, complexity. The evaluation methodology should not focus on a single KPI, and should reuse existing KPIs whenever applicable. where existing KPIs are found to be insufficient new KPIs may be developed as needed. Work groups (WGs) will decide KPIs to evaluate and how.

Study, analysis and identify techniques on a gNB and a UE side to improve network energy savings in terms of both base station (BS) transmission and reception, which may include:

1) How to achieve more efficient operation dynamically and/or semi-statically and finer granularity adaptation of transmissions and/or receptions in one or more of network energy saving techniques in time, frequency, spatial, and power domains, with potential support/feedback from the UE, and potential UE assistance information [RAN1, RAN2]
1) Information exchange/coordination over network interfaces [RAN3]
2) Other techniques are not precluded

There is a need to prioritize idle/empty and low/medium load scenarios (the exact definition of such loads is left to the study), and different loads among carriers and neighbor cells are allowed.

As per RAN1 #109-e meeting, the following gaps were identified in spatial-domain NES techniques. There is a need for techniques and enhancements for the adaptation of number of spatial elements of a network apparatus (e.g., gNB), including (but not limited to) the following aspects:
a) spatial elements may include antenna element(s), TxRU(s) (with sub-array/full-connection), antenna panel(s), TRxP(s) (co-located or geographically separated from each other), logical antenna port(s) (corresponding to specific signals and channels).
b) impact to UE operations from dynamic adaptation of spatial elements, e.g. measurements, CSI feedback, power control, PUSCH/PDSCH repetition, SRS transmission, TCI configuration, beam management, beam failure recovery, radio link monitoring, cell (re)selection, handover, initial access, etc.,
c) Feedback/assistance information from the UE required for support dynamic spatial element adaptation; for example, CSI measurement and reports, SR, etc
d) Signaling methods, including reduced signaling, for enabling dynamic spatial element adaptation; for example, group-common L1 signaling, broadcast signaling, MAC CE, etc.
e) Dynamic TRxP adaptation;
f) Study of triggering on/off conditions for TRxP(s)
a. Note this may not have specification impact and could potentially be up to network implementation.
g) Study of SSB, PL-RS, TRS, and CSI-RS re-configuration and its impact to initial access procedure, synchronization and measurements performed by the idle/inactive/connected UE
h) Dynamic logical port adaptation and efficient port reconfigurations
i) Study details of signaling the port (e.g., NZP CSI-RS ports) (if required to be known by the UE).
j) Study dynamic adaptation (including activation/deactivation) of CSI measurement or report configuration for port adaptation
k) Joint adaptation of spatial-domain, frequency-domain and/or power-domain configurations to avoid coverage loss
l) Grouping of UEs to reduce transmission and reception footprint at the gNB; including but not limited to grouping of users in spatial domain.

It is desired to address the above mentioned disadvantages or other short comings or at least provide a useful alternative.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve a method for managing energy usage in a wireless network. The method includes sending, by a network apparatus, a configuration message comprising at least one power adaptation information to at least one UE in the wireless network to trigger at least one beam measurement report from the at least one UE. Further, the method includes controlling, by the network apparatus, the energy usage in the wireless network based on the configuration message comprising the at least one power adaptation information and a subsequent beam measurement report.

Given that the antenna elements, sub-arrays and panels consume the greatest amount of power in a base-station, muting and/or power adaptation of these spatial elements can provide significant energy savings for the wireless network. The methods in the present disclosure can be used for saving energy, in the power-domain, in the wireless networks using adaptation of CSI-RS port or antenna port powers.

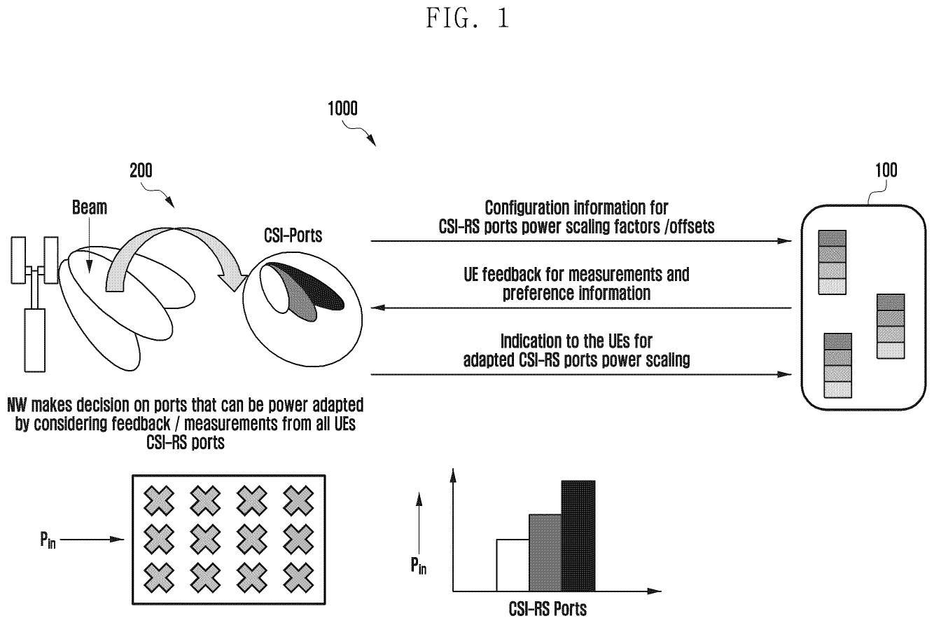

Referring now to the drawings, and more particularly to FIGS. 1 through 3, where similar reference characters denote corresponding features consistently throughout the figures, there are shown at least one embodiment.

FIG. 1 illustrates an overview of a wireless network (1000) for managing energy usage, according to embodiments as disclosed herein. The wireless network (1000) can be, for example, but not limited to a fourth generation (4G) network, a fifth generation (5G) network, a sixth generation (6G) network, an Open Radio Access Network (ORAN) or the like. In an embodiment, the wireless network (1000) includes a UE (100) and a network apparatus (200). The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (200) can be, for example, but not limited to a gNB, a eNB, a new radio (NR) trans-receiver or the like.

In an embodiment, a UE feedback information can be used to identify which CSI-RS ports can have their power boosted/de-boosted. The network apparatus (200) (e.g., gNB or the like) receives Reference Signal Received Quality (RSRP) measurements for all CSI-RS ports, and performs the following:
a. if the minimum RSRP received from all UEs (100) for certain port(s) is above a configured threshold, the port(s) can be candidate(s) for de-boosting power; or
b. if the maximum RSRP received from all UEs (100) for certain port(s) is below a configured threshold, the port(s) can be candidate(s) for boosting power.

Embodiments herein disclose methods for managing energy usage in a wireless network (1000) by a network apparatus (200). The method includes sending a configuration message comprising power adaptation information (e.g., port power adaptation information or the like) to a UE (100) in the wireless network to trigger abeam measurement report from the UE (100). Further, the method includes controlling the energy usage in the wireless network (1000) based on the configuration message comprising the power adaptation information and a subsequent beam measurement report.

Measurements received on the aforementioned (non-empty) set of CSI-RS ports are monitored for a pre-configured period to add hysteresis. The network apparatus (200) (e.g., gNB or the like) identifies a candidate set of CSI-RS ports on which power boosting/de-boosting can be performed. An indication can be provided to UEs (100) about CSI-RS ports which can be considered for port power adaptation.

In an embodiment, based on the CSI-RS beam measurements, in step 1, the network apparatus (200) (e.g., gNB or the like) indicates a candidate list of CSI-RS ports for power adaptation (boost/de-boost) to all (or a group of) UEs (100). In an example, CSI reporting corresponding to N out of L sub-configurations in one reportConfig where each sub-configuration corresponding to an SD adaptation pattern or/and a powerControlOffset value. In step 2, the UE (100) sends measurement report with an indication to restrict certain CSI-RS port(s) from becoming candidate(s) for power boosting/de-boosting, if any. In step 3, the network apparatus (200) (e.g., gNB or the like) will receive the measurement reports from the indicated UEs (100) and their preferences on power adaptation for each port in the candidate list. It is up to gNB's discretion to honour the UE's request. In step 4, the network apparatus (200) (e.g., gNB or the like) can trigger new CSI-RS re-configuration with power adaptation information for all (or a group of) UEs (100).

In an embodiment, based on the CSI-RS beam measurements, the network apparatus (200) (e.g., gNB or the like) performs CSI-RS re-configuration (with power adaptation information) for all (or a group of) UEs (100) in the wireless network (1000) based on past beam measurements (for example, RSRP, SINR, etc.).

The power-adaptation information as part of CSI-RS re-configuration for recovery conditions for power adaptation can be provided in one of two formats:
1a: The network apparatus (200) can de-boost all CSI-RS ports with the same power scaling factor.
1b: The network apparatus (200) can boost all CSI-RS ports with same power scaling factor.
2a: The network apparatus (200) can de-boost the power on each of the CSI-RS port(s) with different scaling factors (on a per BWP/per CC basis).
2b: The network apparatus (200) can boost the power on each of the CSI-RS port(s) with different scaling factors (on a per BWP/per CC basis).
3: The network apparatus (200) can boost the power on a subset of the CSI-RS port(s) and de-boost the power on the rest of the CSI-RS port(s), both with different scaling factors (on a per BWP/per CC basis).
4: In order to reset the port powers quickly, the gNB can set all CSI-RS ports to the same reference power.

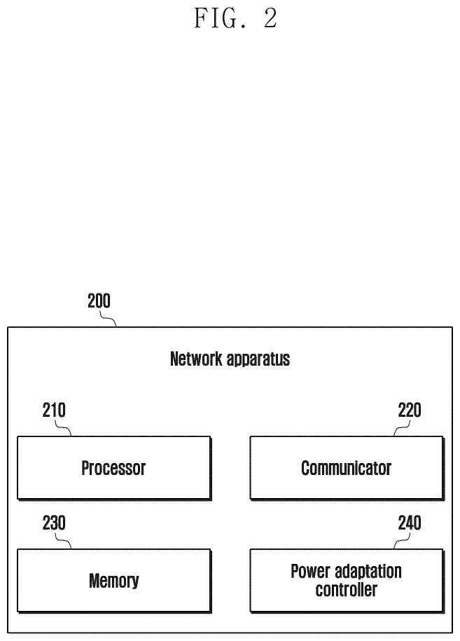

FIG. 2 shows various hardware components of the network apparatus (200), according to the embodiments as disclosed herein. In an embodiment, the the network apparatus (200) includes a processor (210), a communicator (220), a memory (230) and a power adaptation controller (240). The processor (210) is coupled with the communicator (220), the memory (230) and the power adaptation controller (240).

The power adaptation controller (240) sends a configuration message comprising the power adaptation information to the UE (100) in the wireless network (1000) to trigger the beam measurement received from the UE (100). The beam measurement can be, for example, but not limited to a RSRP measurement, a SINR measurement, a RSRQ measurement, a CRI, a RI, a LI, a PMI, and a CQI. The power adaptation information indicates at least one of: at least one power offset value for at least one of a configured CSI-RS resource set and at least one configured CSI-RS resource in the configured CSI-RS resource set.

In an embodiment, the power adaptation information is provided by de-boosting all CSI-RS ports with an identical power scaling factor on the per BWP or the per CC basis. In another embodiment, the power adaptation information is provided by boosting all CSI-RS ports with same power scaling factor on a per BWP or a per CC basis. In another embodiment, the power adaptation information is provided by de-boosting the power on each of a CSI-RS port with different scaling factors on a per BWP) or a per CC basis. In another embodiment, the power adaptation information is provided by boosting the power on each of a CSI-RS port with different scaling factors on a per BWP or a per CC basis. In another embodiment, the power adaptation information is provided by boosting the power on a subset of the CSI-RS port and de-boosting the power on a rest of the CSI-RS port with different scaling factors on a per BWP or a per CC basis. In another embodiment, the power adaptation information is provided by setting all CSI-RS ports to a same reference power on a per BWP or a per CC basis.

In an embodiment, the power adaptation controller (240) indicates the power adaptation information along with one of: at least one CSI-RS port, a single group of CSI-RS ports, a multiple groups of CSI-RS ports for the power adaptation information to the UE (100). In an embodiment, the power adaptation information is indicated to the UE (100) by adapting a transmit power of the CSI-RS ports themselves using at least one powerControlOffsetSS value or a value update associated with the powerControlOffsetSS. The powerControlOffsetSS is ratio of CSI-RS power to SSB power. In another embodiment, the power adaptation information is indicated to the UE (100) by adapting the transmit power of a Physical Downlink Shared Channel (PDSCH) that is quasi-colocated with the CSI-RS ports using at least one of a powerControlOffset value or a value update associated with the powerControlOffset. The powerControlOffset is ratio of PDSCH power to CSI-RS power.

Based on the indication, the power adaptation controller (240) receives the measurement report from the UE (100). The measurement report includes the preference and measurement information about the power adaptation information for the one of: the at least one CSI-RS port, the single group of CSI-RS ports, and the multiple groups of CSI-RS ports. Based on the measurement report, the power adaptation controller (240) sends the configuration message comprising the at least one power adaptation information to the at least one UE (100) in the wireless network (1000).

Based on the configuration message comprising the power adaptation information and the subsequent beam measurement report, the power adaptation controller (240) controls the energy usage in the wireless network (1000).

The power adaptation controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (230).

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 2 shows various hardware components of the network apparatus (200) but it is to be understood that other embodiments are not limited thereon. In other embodiments, the network apparatus (200) may include less or more number of components. Further, the labels or names of the components are used only for illustrative purpose and does not limit the scope of the invention. One or more components can be combined together to perform same or substantially similar function in the network apparatus (200).

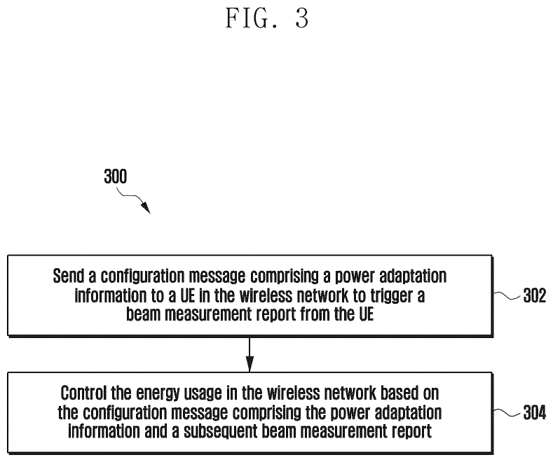

FIG. 3 is a flow chart (300) illustrating a method for managing energy usage in the wireless network (1000), according to embodiments as disclosed herein. The operations (302-304) are handled by the power adaptation controller (240).

The method includes sending the configuration message comprising at least one power adaptation information to at least one UE (100) in the wireless network (1000) to trigger at least one beam measurement report from the at least one UE. Further, the method includes controlling the energy usage in the wireless network (1000) based on the configuration message comprising the power adaptation information and the subsequent beam measurement report.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods for managing energy usage in a wireless network. The method includes sending, by a network apparatus, a configuration message comprising at least one beam adaptation information to at least one UE in the wireless network to trigger at least one beam measurement report from the at least one UE. Further, the method includes controlling, by the network apparatus, the energy usage in the wireless network based on the configuration message comprising the at least one beam adaptation information and a subsequent beam measurement report.

The method can be used for saving energy in the wireless networks (in a spatial-domain) using beam adaptation information (e.g., port beam-width adaptation or the like).

In an embodiment, one or more CSI-RS resources from a CSI-RS resource set for channel measurement can be associated with a same sub-configuration provided in a CSI report configuration. Resources in the resource set for channel measurement have the same number of antenna ports.

Given that the antenna elements, sub-arrays and panels consume the greatest amount of power in a base-station, beam adaptation of these spatial elements can provide significant energy savings for the wireless network. The methods mentioned here can be used for saving energy in the wireless networks (in the spatial-domain) by applying beam adaptation techniques.

Referring now to the drawings, and more particularly to FIGS. 1 through 3, where similar reference characters denote corresponding features consistently throughout the figures, there are shown at least one embodiment.

FIG. 1 illustrates an overview of a wireless network (1000) for managing energy usage, according to embodiments as disclosed herein. The wireless network (1000) can be, for example, but not limited to a fourth generation (4G) network, a fifth generation (5G) network, a sixth generation (6G) network, an Open Radio Access Network (ORAN) or the like. In an embodiment, the wireless network (1000) includes a UE (100) and a network apparatus (500). The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (200) can be, for example, but not limited to a gNB, a eNB, a new radio (NR) trans-receiver or the like.

In an embodiment, feedback information from the UE (100) can be used to identify which CSI-RS ports to choose for beam adaptation. The network apparatus (500) receives RSRP measurements for all CSI-RS ports and performs at least one of the following:
a. If the minimum RSRP received from all UEs (100) for certain port(s) is above a configured threshold, the port(s) can be candidate(s) for beam widening; or
b. If maximum RSRP received from all UEs for certain port(s) is below a configured threshold, the port(s) can be candidate(s) for beam shrinking.

Embodiments herein disclose methods for managing energy usage in a wireless network (1000) by a network apparatus (500). The method includes sending a configuration message including beam adaptation information to a UE (100) in the wireless network (1000) to trigger the beam measurement report from the UE (100). Further, the method includes controlling the energy usage in the wireless network (1000) based on the configuration message including the beam adaptation information and a subsequent beam measurement report.

The measurements received on the aforementioned (non-empty) set of CSI-RS ports are monitored for the pre-configured period to add hysteresis. The network apparatus (500) can identify a candidate set of CSI-RS ports on which beam widening/shrinking can be performed. An indication can be provided to the UEs (100) about muted subset of CSI-RS ports to minimize UE measurements.

In an embodiment, based on CSI-RS beam measurements, in step 1, the network apparatus (500) indicates the candidate list of CSI-RS ports for beam adaptation (widening/shrinking) to all (or a group of) UEs. In step 2, the UE (100) sends the measurement report with the indication to restrict certain CSI-RS port(s) from becoming candidate(s) for beam adaptation, if any. In step 3, the network apparatus (500) receives the measurement reports from the indicated UEs (100) and their preferences on beam adaptation for each port in the candidate list. It is up to network apparatus (500)'s discretion to honour the UE's request. In step 4, the network apparatus (500) triggers a new CSI-RS re-configuration with beam adaptation information for all (or a group of) UEs.

In an embodiment, based on the CSI-RSbeam measurements, the network apparatus (500) performs the CSI-RS re-configuration (with beam adaptation information) for all (or the group of) UEs in the network (1000) based on past beam measurements (for example, RSRP, SINR, etc.).

The beam adaptation information as part of CSI-RS re-configuration for recovery conditions for beam adaptation can be provided in one of two formats:
1a: The network apparatus (500) can widen the beam-width for the chosen set of CSI-RS ports with same scaling factor.
1b: The network apparatus (500) can shrink the beam-width for the chosen set of CSI-RS ports with same scaling factor.
2a: The network apparatus (500) can widen the beam-width on each of the CSI-RS port(s) with different scaling factors (on a per BWP/per CC basis).
2b: The network apparatus (500) can shrink the beam-width on each of the CSI-RS port(s) with different scaling factors (on a per BWP/per CC basis).
3: The network apparatus (500) can widen the beam-width on a subset of the CSI-RS port(s) and shrink the beam-width on the remaining CSI-RS port(s), both with different scaling factors (on a per BWP/per CC basis).
4: In order to reset the port beam-widths quickly, the gNB can set all CSI-RS ports to the same default beam-width.

The above operations are explained in the context of beam-width, but the same operations are applicable for other beam adaptation information (e.g., beam angle, beam tilt, beam radiation pattern, and CSI-RS port power) as well.

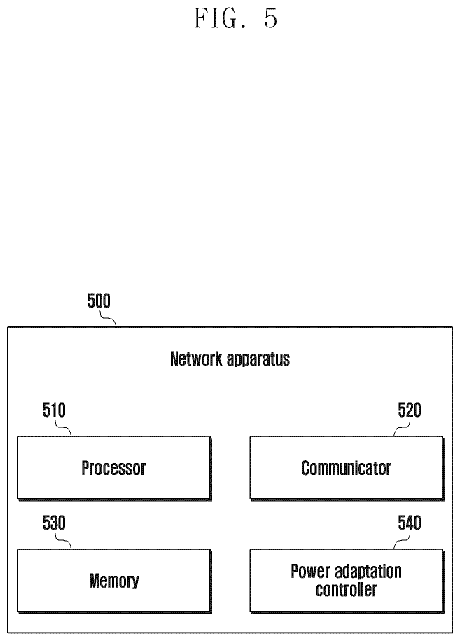

FIG. 5 shows various hardware components of the network apparatus (500), according to the embodiments as disclosed herein. In an embodiment, the the network apparatus (500) includes a processor (510), a communicator (520), a memory (530) and a beam adaptation controller (540). The processor (510) is coupled with the communicator (520), the memory (530) and the beam adaptation controller (540).

The beam adaptation controller (540) sends a configuration message comprising the beam adaptation information to the UE (100) in the wireless network (1000) to trigger the beam measurement received from the UE (100). The beam adaptation information can be, for example, but not limited to a beam width, a beam angle, a beam tilt, a beam radiation pattern, and the CSI-RS port power. In an embodiment, the beam adaptation information involves enabling at least one antenna element and at least one antenna sub-array associated to a logical antenna port. In an embodiment, the beam adaptation information involves disabling the at least one antenna element and the at least one antenna sub-array associated to the logical antenna port. In an embodiment, at least one CSI-RS port associated with the beam adaptation information comprises at least one of the beam width, the beam angle, the beam tilt, the beam radiation pattern, and the CSI-RS port power. In an embodiment, at least one single group of CSI-RS ports associated with the beam adaptation information comprises at least one of the beam width, the beam angle, the beam tilt, the beam radiation pattern, and the CSI-RS port power. In an embodiment, at least one multiple groups of CSI-RS ports associated with the beam adaptation information comprises at least one of the beam width, the beam angle, the beam tilt, the beam radiation pattern, and the CSI-RS port power. The beam measurement can be, for example, but not limited to the RSRP measurement, the SINR measurement, the RSRQ measurement, a CRI, a RI, a LI, a PMI, and a CQI.

In an embodiment, the beam adaptation information is provided by widening a beam parameter for a selected set of CSI-RS ports from a candidate list of CSI-RS port subsets with a same scaling factor (in an example, a CSI resource set may contain two CSI resources with same number of CSI-RS ports such that the beam-width on the second is roughly 3 dB larger than that of the first, assuming half of the antenna elements are used for the second compared to the first) on a per BWP or a per Component carrier (CC) basis. In another embodiment, the beam adaptation information is provided by narrowing a beam parameter for a selected set of CSI-RS ports from a candidate list of CSI-RS port subsets with a same scaling factor (In an example, the CSI resource set may contain two CSI resources with same number of CSI-RS ports such that the beam-width on the second is roughly 6 dB smaller than that of the first, assuming one-fourth of the antenna elements are used for the second compared to the first) on a per BWP or a per CC basis. In another embodiment, the beam adaptation information is provided by widening a beam parameter for a selected set of CSI-RS ports from the candidate list of CSI-RS port subsets with a different scaling factor on a per BWP or a per CC basis. In another embodiment, the beam adaptation information is provided by narrowing a beam parameter for a selected set of CSI-RS ports from the candidate list of CSI-RS port subsets with a different scaling factor on a per BWP or a per CC basis. In another embodiment, the beam adaptation information is provided by widening a beam parameter for a selected subset of CSI-RS ports from the a candidate list of CSI-RS port subsets and narrowing the beam parameter for a non-overlapping subset of CSI-RS ports from the candidate list of CSI-RS port subsets on a per BWP or a per CC basis. In another embodiment, the beam adaptation information is provided by widening a beam parameter, along with power boosting or de-boosting, for a selected subset of CSI-RS ports from the candidate list of CSI-RS port subsets with a corresponding same scaling factor or a different scaling factor on a per BWP or a per CC basis. In another embodiment, the beam adaptation information is provided by narrowing a beam parameter, along with the power boosting or de-boosting, for a selected subset of CSI-RS ports from the candidate list of CSI-RS port subsets with a corresponding same scaling factor or a different scaling factor on a per BWP or a per CC basis. In another embodiment, the beam adaptation information is provided by widening the beam parameter, along with power de-boosting, for the selected subset of CSI-RS ports from the candidate list of CSI-RS port subsets and narrowing the beam parameter, along with power boosting, for a non-overlapping subset of CSI-RS ports from the candidate list of CSI-RS port subsets on aper BWP or a per CC basis. In another embodiment, the beam adaptation information is provided by widening and/or narrowing beam-width of two non-overlapping subsets of CSI-RS ports along with power boosting and/or de-boosting for them, respectively. In another embodiment, the beam adaptation information is provided by setting all CSI-RS ports to a default beam adaptation information on a per BWP or a per CC basis.

In an embodiment, the beam adaptation controller (540) indicates one of: the CSI-RS port, the single group of CSI-RS ports, and the multiple groups of CSI-RS ports for the beam adaptation information to the UE (100). In an embodiment, the power adaptation information is indicated to the UE (100) by adapting a transmit power of the CSI-RS ports themselves using a powerControlOffsetSS value or a value update. The powerControlOffsetSS value is a ratio of CSI-RS power to the SSB power. In another embodiment, the power adaptation information is indicated to the UE (100) by adapting the transmit power of a PDSCH that is quasi-colocated with the CSI-RS ports using a powerControlOffset value or a value update. The powerControlOffset value is a Ratio of PDSCH power to CSI-RS power.

Based on the indication, the beam adaptation controller (540) receives the measurement report from the UE (100). The measurement report includes a preference and measurement information for each of the beam adaptation in one of: the CSI-RS port, the single group of CST-RS ports, and the multiple groups of CST-RS ports. Further, the beam adaptation controller (540) sends the configuration message including the beam adaptation information to the UE (100) in the wireless network (1000) based on the measurement report.

Based on the configuration message comprising the beam adaptation information, the beam adaptation controller (540) controls the energy usage in the wireless network (1000).

The beam adaptation controller (540) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (510) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (510) may include multiple cores and is configured to execute the instructions stored in the memory (530).

Further, the processor (510) is configured to execute instructions stored in the memory (530) and to perform various processes. The communicator (520) is configured for communicating internally between internal hardware components and with external devices via one or more networks. The memory (530) also stores instructions to be executed by the processor (510). The memory (530) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (530) may, in some examples, be considered a non-transitory storage medium. The term “non-transitory” may indicate that the storage medium is not embodied in a carrier wave or a propagated signal. However, the term “non-transitory” should not be interpreted that the memory (530) is non-movable. In certain examples, a non-transitory storage medium may store data that can, over time, change (e.g., in Random Access Memory (RAM) or cache).

Although the FIG. 5 shows various hardware components of the network apparatus (500) but it is to be understood that other embodiments are not limited thereon. In other embodiments, the network apparatus (500) may include less or more number of components. Further, the labels or names of the components are used only for illustrative purpose and does not limit the scope of the invention. One or more components can be combined together to perform same or substantially similar function in the network apparatus (500).

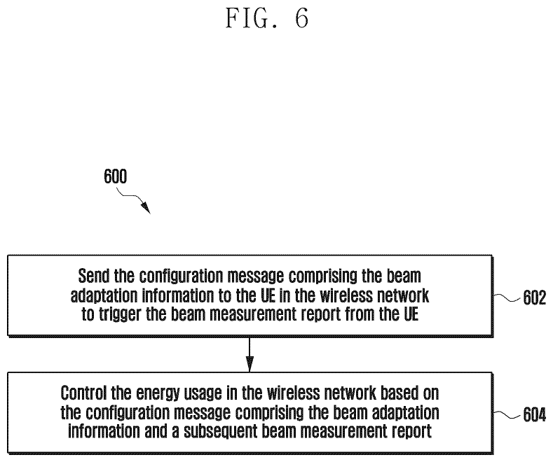

FIG. 6 is a flow chart (600) illustrating a method for managing energy usage in the wireless network (1000), according to embodiments as disclosed herein. The operations (602-604) are handled by the beam adaptation controller (540).

At 602, the method includes sending the configuration message comprising the beam adaptation information to the UE (100) in the wireless network (1000) to trigger the beam measurement report from the UE (100). At 604, the method includes controlling the energy usage in the wireless network (1000) based on the configuration message comprising the beam adaptation information and a subsequent beam measurement report.

The various actions, acts, blocks, steps, or the like in the flow chart (300, 600) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1-15. (canceled)

16. A method for network energy saving (NES) performed by a base station in a wireless communication system, the method comprising:
transmitting, to a terminal, configuration information for a measurement of a channel state information reference signal (CSI-RS), the configuration information including a list of candidate CSI-RS ports and power adaptation information for each of the candidate CSI-RS ports; and
receiving, from the terminal, a measurement report associated with the measurement,
wherein the candidate CSI-RS ports correspond to a subset of CSI-RS ports.

17. The method of claim 16,
wherein the power adaptation information corresponds to a power offset for the CSI-RS, and
wherein the power offset is associated with a ratio between a physical downlink shared channel (PDSCH) power to a CSI-RS power.

18. The method of claim 16, wherein the configuration information is configured per bandwidth part (BWP) and per component carrier (CC).

19. The method of claim 16, wherein the measurement report includes at least one of a reference signal received power (RSRP) or a signal-to-interference and noise ratio (SINR).

20. The method of claim 16, wherein the CSI-RS ports are for a channel measurement.

21. A method for network energy saving (NES) performed by a terminal in a wireless communication system, the method comprising:
receiving, from a base station, configuration information for a measurement of a channel state information reference signal (CSI-RS), the configuration information including a list of candidate CSI-RS ports and power adaptation information for each of the candidate CSI-RS ports; and
transmitting, to the base station, a measurement report based on the measurement,
wherein the candidate CSI-RS ports correspond to a subset of CSI-RS ports.

22. The method of claim 21,
wherein the power adaptation information corresponds to a power offset for the CSI-RS, and
wherein the power offset is associated with a ratio between a physical downlink shared channel (PDSCH) power to a CSI-RS power.

23. The method of claim 21, wherein the configuration information is configured per bandwidth part (BWP) and per component carrier (CC).

24. The method of claim 21, wherein the measurement report includes at least one of a reference signal received power (RSRP) or a signal-to-interference and noise ratio (SINR).

25. The method of claim 21, wherein the CSI-RS ports are for a channel measurement.

26. A base station for network energy saving (NES) in a wireless communication system, the base station comprising:
a transceiver; and
at least one processor coupled with the transceiver and configured to:
transmit, to a terminal, configuration information for a measurement of a channel state information reference signal (CSI-RS), the configuration information including a list of candidate CSI-RS ports and power adaptation information for each of the candidate CSI-RS ports, and
receive, from the terminal, a measurement report associated with the measurement,
wherein the candidate CSI-RS ports correspond to a subset of CSI-RS ports.

27. The base station of claim 26,
wherein the power adaptation information corresponds to a power offset for the CSI-RS, and
wherein the power offset is associated with a ratio between a physical downlink shared channel (PDSCH) power to a CSI-RS power.

28. The base station of claim 26, wherein the configuration information is configured per bandwidth part (BWP) and per component carrier (CC).

29. The base station of claim 26, wherein the measurement report includes at least one of a reference signal received power (RSRP) or a signal-to-interference and noise ratio (SINR).

30. The base station of claim 26, wherein the CSI-RS ports are for a channel measurement.

31. A terminal for network energy saving (NES) in a wireless communication system, the terminal comprising:
a transceiver; and
at least one processor coupled with the transceiver and configured to:
receive, from a base station, configuration information for a measurement of a channel state information reference signal (CSI-RS), the configuration information including a list of candidate CSI-RS ports and power adaptation information for each of the candidate CSI-RS ports, and
transmit, to the base station, a measurement report based on the measurement,
wherein the candidate CSI-RS ports correspond to a subset of CSI-RS ports.

32. The terminal of claim 31,
wherein the power adaptation information corresponds to a power offset for the CSI-RS, and
wherein the power offset is associated with a ratio between a physical downlink shared channel (PDSCH) power to a CSI-RS power.

33. The terminal of claim 31, wherein the configuration information is configured per bandwidth part (BWP) and per component carrier (CC).

34. The terminal of claim 31, wherein the measurement report includes at least one of a reference signal received power (RSRP) or a signal-to-interference and noise ratio (SINR).

35. The terminal of claim 31, wherein the CSI-RS ports are for a channel measurement.
